(19) United States
(12) Patent Application Publication
(10) Pub. No.: US 2010/0124683 A1
(43) Pub. Date: May 20, 2010

(54) HEAT SPREADER ASSEMBLY FOR USE WITH A DIRECT OXIDATION FUEL CELL

(75) Inventors: Charles M. Carlstrom, JR., Saratoga Springs, NY (US); Constantinos Minas, Slingerland, NY (US); George Allen, Albany, NY (US); John E. Meschter, New York, NY (US); Amit Chaugule, Guilderland, NY (US); James K. Prueitt, Ballston Lake, NY (US)

Correspondence Address: CESARI AND MCKENNA, LLP, 88 BLACK FALCON AVENUE, BOSTON, MA, 02210, US

(73) Assignee: MTI MICROFUEL CELLS INC., Albany, NY (US)

(21) Appl. No.: 12/274,453

(22) Filed: Nov. 20, 2008

(51) Int. Cl. H01M 2/00; B21D 53/02

(52) U.S. Cl. 429/26; 156/242

(57) ABSTRACT

A heat spreader assembly that provides electrical, thermal and structural functions to the fuel cell. The heat spreader assembly comprises two bulk composite material layers, and a heat spreader element. The heat spreader element includes a copper layer sandwiched between two stainless steel layers. The stainless steel layers are bonded to the bulk composite layers by a conductive thermal set adhesive. The lamination applied to the stainless steel layers enables heat and electricity to flow from the cathode while maintaining low resistance among other layers of the fuel cell. The copper layer diffuses heat across the layer and functions as cathode current collector for a fuel cell. The bulk composite material layers function as a cold side of an enthalpy exchanger system and a cathode flow field. Further the composite material includes flow channels formed throughout the material to evenly distribute incoming air over the enthalpy exchanger membrane and to the cathode of the MEA.

### CROSS REFERENCE TO RELATED APPLICATION

This application is related to commonly owned United States Patent Application of Leach, et al. entitled DIRECT OXIDATION FUEL CELL SYSTEM WITH UNIFORM VAPOR DELIVERY OF FUEL which is being filed on even date herewith and is identified by Attorney Docket No. 107044-0077, and which is presently incorporated by reference herein in its entirety.

### FIELD OF THE INVENTION

This invention relates generally to a heat spreader for use with a direct oxidation fuel cell.

### BACKGROUND OF THE INVENTION

Fuel cell power systems that convert an organic fuel such as methanol or ethanol and an oxidant into electricity are generally categorized into two types. In the first type, a fuel reformer is used to convert the organic fuel stream into a fuel stream containing hydrogen gas. The hydrogen gas is fed to the anode of a hydrogen-fueled fuel cell.

The second type is a direct oxidation fuel cell (DOFC) in which the organic fuel is reacted directly at an anode catalyst electrode of a membrane electrode assembly (MEA) of the fuel cell. An example of a direct oxidation fuel cell is the direct methanol fuel cell (DMFC). The half reactions for a DMFC are:

Anode: CH₃OH+H₂O→CO₂+6e⁻+6H⁺

Cathode: 6e⁻+6H⁺+ 3/2O₂→3H₂O

Many DMFC systems known in the art are liquid-feed systems that circulate a low-molarity methanol/water fuel solution through an anode flow field adjacent to an anode gas diffusion layer (GDL). Carbon dioxide (CO₂) that is generated in the anode reaction exits through the anode flow field with the unused fuel solution where it is separated before the unused fuel solution is recirculated through the anode flow field.

Some liquid-feed DMFC systems operate using substantially 100% methanol and employ an active system to manage water in the fuel cell. Water is needed for the anode half reaction (as noted in the above reaction equations). Additionally, the cathode aspect of the membrane must be kept adequately hydrated, but not saturated or flooded. Thus, active water management systems are employed that include techniques for capturing water generated at the cathode and returning it to the anode. This replaces: (i) water lost to the anode reaction, (iii) water leaving the system through the CO₂ vent, or (iii) water crossing over the polymer-electrolyte membrane (PEM) from the anode to the cathode. These active water management systems can become complex, adding costs, as well as size and weight, to a system that should be small and lightweight to satisfy commercial applications.

Furthermore, it has been found that DOFCs operate best when fuel and oxygen are delivered uniformly to an adequately-hydrated MEA. In a liquid-feed system, water is mixed with the fuel, which provides hydration of the PEM. In addition, fuel is provided in concentration levels adequate to evenly feed the full active area of the membrane. Concentration of the fuel can be managed so that the beginning of the flow path is not over concentrated and the end of the flow path is not under concentrated. In such cases, the energy required to distribute the fuel across the MEA active area comes from a liquid pump. But, these systems also require water delivery and/or recirculation mechanisms such as pumps and conduits for recirculating unused fuel and water back to the anode of the fuel cell.

It is also known to provide a direct-injection fuel feed DOFC in which liquid fuel is directly injected into the anode chamber of the fuel cell. In this case, any fuel that escapes unused is not captured and circulated back through the anode chamber. For example, U.S. Pat. No. 6,447,942 describes a direct methanol fuel cell in which liquid fuel is introduced to the anode by capillary action to a porous material that acts as a wick and which stays wetted with fuel. Another example of a direct-injection fuel cell system is commonly owned U.S. Pat. No. 6,981,877 of Ren et al, for a SIMPLIFIED DIRECT-OXIDATION FUEL CELL SYSTEM, which describes a direct-injection fuel feed system that feeds substantially 100% methanol to an anode chamber without active collection or pumping of water produced at the cathode. Other DOFCs provide fuel in evaporated methanol form to the anode. For example, commonly owned United States Published Patent Application No. US2005/0170224 of Ren et al, for a CONTROLLED DIRECT LIQUID INJECTION VAPOR FEED, describes a system in which liquid fuel is injected with a pump into an evaporator pad by a device with many injection ports; in another embodiment a dispersion member is placed between the evaporator pad and the anode GDL to effectively disperse the fuel.

Challenges are presented in such designs that include managing hydraulic and gravitational pressure in various orientations, as well as in providing components that adjust for the concentration of fuel in the evaporation pad being highest at the injection ports, in order to more uniformly distribute the fuel.

Notably, these prior techniques for direct injection of fuel feed in a vapor form each describe the liquid-to-vapor transition happening in close proximity to the anode GDL. In such designs, the fuel is distributed from a single point fuel source across the active area of the fuel cell. However, because it is difficult to uniformly distribute the vaporous fuel, water can build up in areas where there is a lower concentration of fuel. Prior techniques attempt to mitigate the water problem by providing a dispersion member between an evaporation pad and the anode catalyst, however this still leaves void spaces in which water can collect. It has been found that the fuel diffuses through water droplets at a diffusion rate that is orders of magnitude lower than fuel diffusing through gas such as CO₂. Thus, randomly distributed water droplets in the anode chamber void spaces can still result in a spatially non-uniform distribution of fuel to the anode catalyst which reduces performance.

In addition, there is also a temperature dependency that leads to degraded performance. More specifically, as noted, prior designs involve a liquid-to-vapor transition that happens in close proximity to the anode aspect of the MEA. The vapor delivery rate to the anode catalyst in such prior techniques is a function of the vapor pressure of fuel and the porosity of the fuel distribution layers. But the vapor pressure of the fuel is dependent upon the temperature at the area where the evaporation occurs. It has been found that, for a given porosity of layers between the liquid fuel and the anode catalyst, the vapor pressure of the vaporous fuel results in a desired fuel feed rate to the anode catalyst only at a single design point temperature. However, if the temperature in that area of the fuel cell is higher than this single design point temperature, then the vapor pressure is affected and a higher fuel-feed rate occurs. When the temperature is lower than the single design point temperature, then the vapor pressure is such that a lower fuel feed rate results. Thus, the vapor pressure and fuel feed rate are difficult to control due to this temperature dependency.

The temperature dependency can be worsened by the heat of the fuel cell operation itself. As the fuel cell reactions occur, heat can build up which may affect the temperature at the MEA, and cause the cathode to dry out.

Another problem is caused by the heat loss due to vaporization of the fuel acting to cool an area to a temperature that is lower then the membrane and catalyst layers. If the cooling is sufficient, then water generated by the fuel cell reaction at the MEA temperature may have a dew point that is higher than the temperature of the evaporation area of the fuel cell. This can result in condensation of water at the evaporator surface in the anode chamber, thus leading to the problems discussed above regarding build up of water in the active area of the anode.

There remains a need, therefore, for a direct oxidation fuel cell system that removes heat from the fuel cell, maintains an even MEA temperature, and allows sufficient air and water to the cathode aspect of the fuel cell. There remains yet a further need for a direct oxidation fuel cell system having heat and water management features that add minimum complexity, weight, and/or size when integrated into the fuel cell system.

### SUMMARY OF THE INVENTION

The present invention overcomes the disadvantages of the prior art by providing a multi-function heat spreader assembly for use with a fuel cell. The heat spreader assembly comprises a heat spreader element, and a bulk composite material layer. Preferably, the heat spreader element includes a copper layer sandwiched between two stainless steel layers. The stainless steel layers are roll bonded onto the copper. The bulk composite material layers are then glued to the stainless layers using a similar composite material or conductive thermal set adhesive. The lamination enables heat and electricity to flow from the cathode while maintaining low resistance among other layers of the fuel cell system.

The bulk composite material layers function as a cold side of an enthalpy exchanger and cathode flow field. Both layers include flow channels for evenly distributing air to the cathode and enthalpy exchanger.

The heat spreader assembly performs a number of functions within a fuel cell system. The heat spreader element functions to disperse heat generated by the reactions in the fuel cell. It also functions as a current collector for the electricity generated by the fuel cell, and it acts as a flow field plate for both, the cathode and the cold side of an enthalpy exchanger. The assembly also provides compression for MEA conductivity and integrity of the fuel cell system. With many functions being performed by a single assembly, the present invention reduces the number of components required in the fuel cell system, thereby contributing to a smaller form factor, and simplification of the manufacturing process.

The heat spreader assembly may be produced by either a hot bonding process or an over molding process. Alternatively, the heat spreader assembly may be formed from aluminum and coated with a conductive impermeable coating.

### BRIEF DESCRIPTION OF THE DRAWINGS

The invention description below refers to the accompanying drawings, of which:

FIG. 1 is an exploded view of a heat spreader assembly constructed in accordance with an illustrative embodiment of the present invention;

FIG. 2A is an isometric illustration of the heat spreader assembly in FIG. 1;

FIG. 2B is a side view of the heat spreader assembly of FIG. 2A;

FIG. 3A is isometric illustration of the heat spreader assembly constructed in accordance with an alternative embodiment of the present invention;

FIG. 3B is a side view of the heat spreader assembly of FIG. 3A;

FIG. 4A is isometric illustration of the heat spreader assembly constructed in accordance with an alternative embodiment of the present invention;

FIG. 4B is a side view of the heat spreader assembly of FIG. 4A;

FIG. 5 is isometric illustration of two heat spreader assemblies constructed in accordance with an alternative embodiment of the present invention;

FIG. 6A is isometric illustration of a fuel cell stack which includes two heat spreader assemblies constructed in accordance with an illustrative embodiment of the present invention; FIG. 6B is an exploded view of the fuel cell assembly of FIG. 6A;

FIG. 7A is an exploded view of a fuel cell stack constructed in accordance with an alternative embodiment of the present invention; and

FIG. 7B is an exploded view of a fuel cell stack constructed in accordance with an alternative embodiment of FIG. 7A.

### DETAILED DESCRIPTION OF AN ILLUSTRATIVE EMBODIMENT

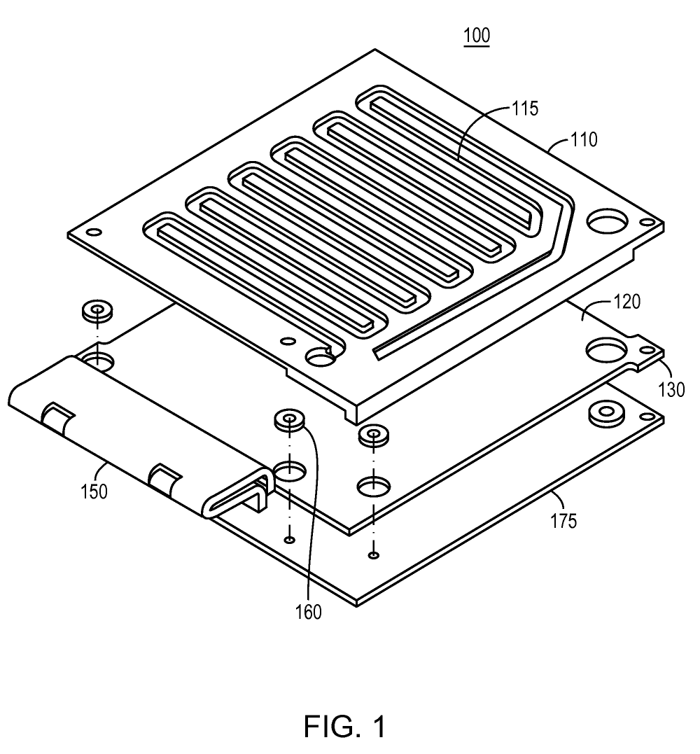

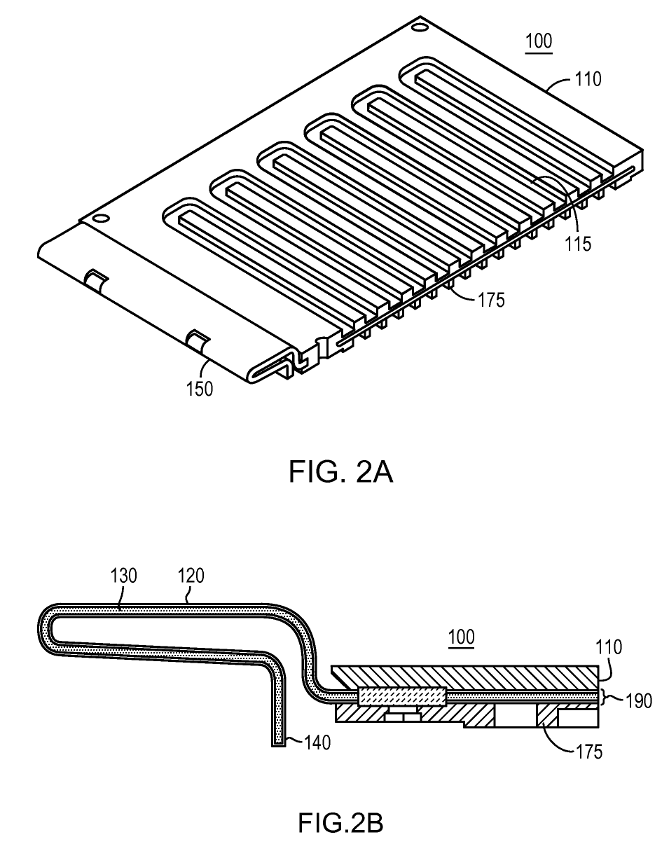

FIG. 1 depicts a heat spreader assembly 100 in accordance with one embodiment of the present invention. The heat spreader assembly 100 includes two bulk composite material layers 110 and 175, and a heat spreader element 190 (shown in FIG. 2B).

The heat spreader element 190, as shown in FIG. 2B, is formed from a first layer of stainless steel 120, a copper plate 130, and a second layer of stainless steel 140. The copper plate 130 consists of approximately 0.020″ thick Cu sheet roll. Each stainless steel layer is approximately 0.002″ thick. The stainless steel layers provide a protective barrier to prevent fuel, water, or other by products from contacting the copper plate. In other words, the stainless steel layers 120, 140 isolate the copper plate 130 from the fuel cell to avoid corrosion and cell contamination.

Further, each stainless steel layer is laminated with a thermal set conductive composite material, such as BMCI (Bulk Molding Compounds Inc.). The lamination enables heat and electricity to flow from the cathode while maintaining low resistance among other layers of the fuel cell.

One edge of the heat spread element 190 extends to form a heat switch tab 150, as shown best in FIG. 2A and 2B. The heat switch tab 150 provides additional surface area which serves to dissipate excess heat generated by the fuel cell (not shown).

The bulk composite material layer 110 comprises an electrically conductive bulk molding compound, such as BMC 940 or BMC 945 from Bulk Molding Compounds, Inc. The heat spreader element 190 provides desired stiffness and dimensional stability for the fuel cell. In addition, flow channels 115 are formed in the bulk composite material to allow even distribution of incoming air across the surface of the cold side of the enthalpy exchanger. Furthermore, as described below, the bulk composite material layer 110 functions as a cold side component of an enthalpy exchanger system in the fuel cell.

Additionally, the heat spreader assembly 100 may include a cathode flow field plate 175 (shown in FIGS. 2A and 2B) located below the heat spreader element 190. In other words, the cathode flow field plate 175 is attached to the heat spreader element 190 on the opposite side of the cold side of the enthalpy exchanger 110. The cathode flow field plate 175 includes flow channels that distribute air evenly across the cathode aspect of the MEA (not shown). The cathode flow field plate 175 is the second layer of bulk composite material.

The combination of the heat spreader element 190 and the bulk composite material layer 110 and 175 functions as a heat spreader assembly that disperses heat generated the fuel cell.

In a first embodiment, the bulk composite material layers 110 and 175 are glued to the stainless steel layers 120 and 140 using a composite material similar to the material of the bulk composite material layer 110. The glue is applied to the stainless steel layers 120 and 140 using a roller just prior to the bulk composite material layers 110 and 175 being compressed at a high temperature in a heat press. Additionally, gaskets 160 (from FIG. 1) seal the air flowing between the cathode and the cold side of the enthalpy exchanger. The glue between the stainless steel and the bulk composite material layers 110 and 175 substantially fills all gaps between the bulk composite material layers and the heat spreader element 190. The composite glue improves both thermal and electrical conductivity between the membrane electrode assembly (MEA) (not shown) and the heat spreader element 190.

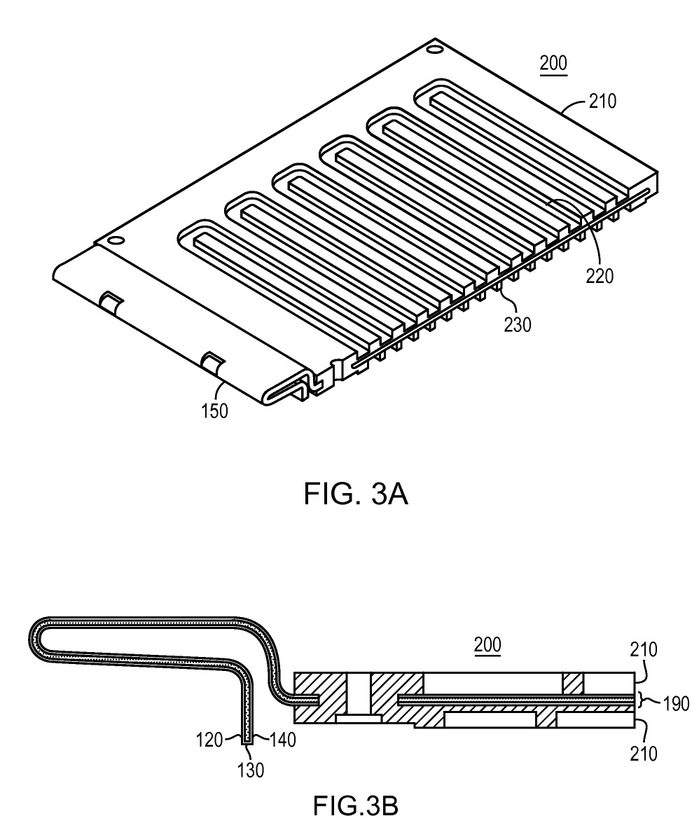

FIGS. 3A and 3B depict a first alternative embodiment of making a heat spreader assembly. The heat spreader assembly 200 is formed from molding a thermal material or thermal set material around the heat spreader element 190. Furthermore, in the molding process, gaskets are not necessary because the thermal material or thermal set material substantially fills all gaps between the bulk composite material layer 210 and the heat spreader element 190 during the molding process. During the molding process, the bulk composite material layer 210 is formed to create a top layer and a bottom layer around the heat element. The lower layer functions as a cathode flow field plate similar to the cathode flow field plate 175. Additionally, during the molding process, flow channels 220 and 230 are formed on surfaces of the top and bottom layers, respectively, of the bulk composite material layer 210. The flow channels 230 allow even distribution of incoming air across the surface of the cathode aspect or cathode diffusion layers.

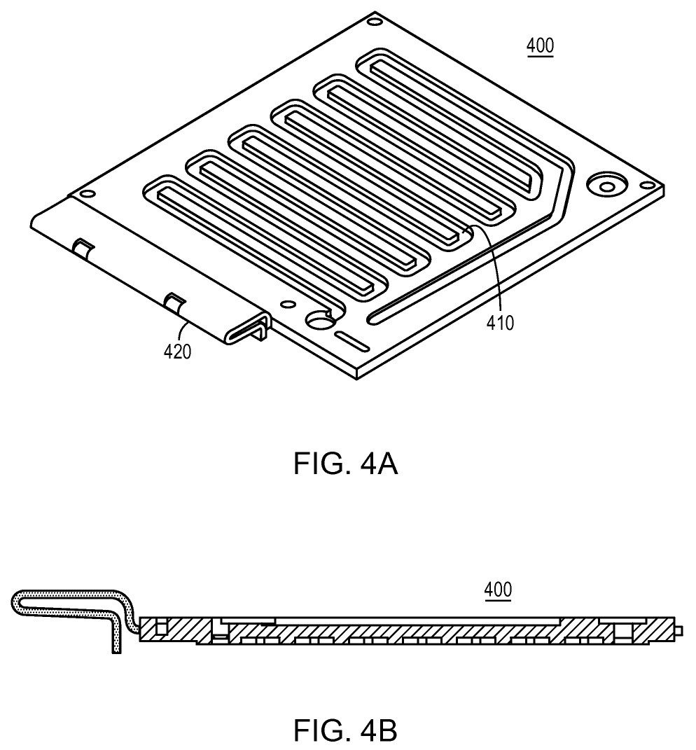

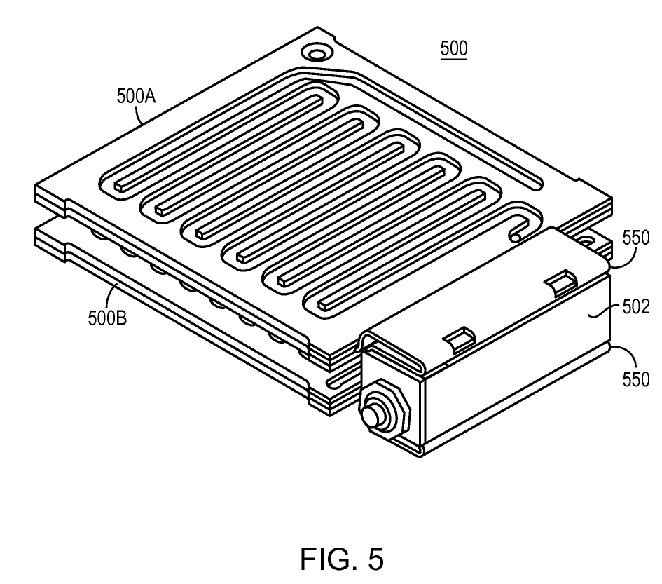

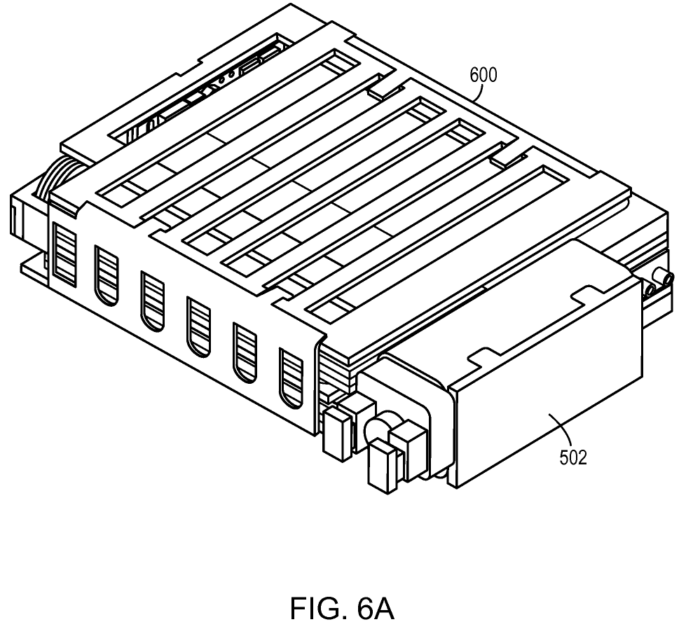

FIGS. 4A and 4B depict a second alternative embodiment of a method of making a heat spreader assembly. A heat spreader assembly 400 is formed from aluminum and then sealed with a conductive impermeable coating, such as available from Impact Coatings. The impermeable coating prevents fuel, water, or other byproducts from contacting the aluminum. In other words, the impermeable coating isolates the aluminum layer from the fuel cell to avoid corrosion and cell contamination. The heat spreader assembly 400 still incorporates flow channels 410 and a heat switch tab 420. However, the aluminum effectively replaces the copper plate 130, stainless steel layers 120, 140, and the bulk composite material layers 110 and 175 from FIG. 1.

FIG. 5 depicts an illustrative embodiment of two heat spreader assemblies 500 in accordance with another embodiment of the present invention. The heat spreader assemblies 500A, 500B are mechanically connected together by a heat switch 502. The heat switch 502 represents a mechanism that makes thermal contact between the heat spreader 190 and the heat sink (not shown). The heat switch makes thermal contact with the heat sink when the fuel cell is too hot, and breaks the thermal contact when the fuel cell is too cold. At cold ambient temperatures, for example 0 deg C., less heat flows out through the heat switch to the heat sink and more heat leaks out through the insulation layer. At hot ambient temperatures, for example 40 deg, there is a smaller temperature difference between the fuel cell and ambient so less heat leaks out through the insulation and more heat conducts through the heat switch to the heat sink. More insulation allows the fuel cell to operate in a colder ambient environment.

The heat spreader assemblies 500A, 500B in FIG. 5 may be constructed using the hot bonding process depicted in FIGS. 1, 2A and 2B, the over molded process depicted in FIGS. 3A and 3B, or formed from aluminum and coated with a conductive impermeable coating depicted in FIGS. 4A and 4B.

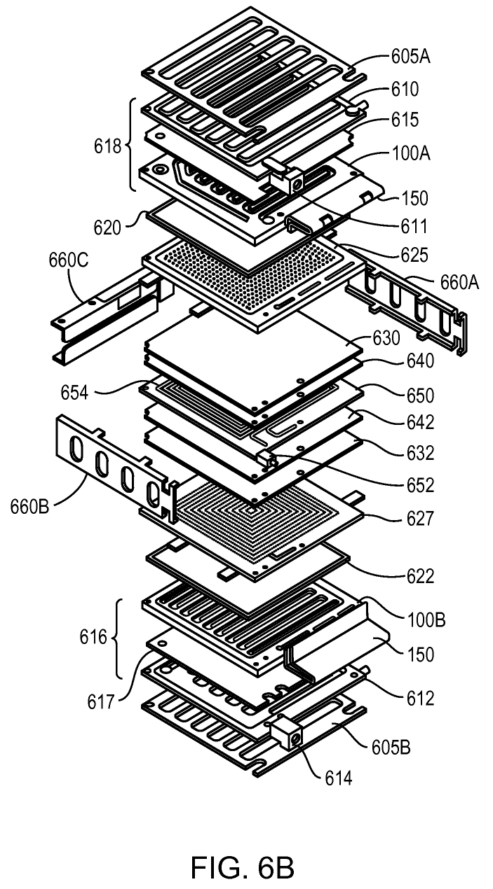

In accordance with a further aspect of the invention, as shown in FIG. 6A, two fuel cells are arranged in a monopolar stack to form a fuel cell system 600. Further details of the functionality and composition of each component of system 600 may be found in the related application “DIRECT OXIDATION FUEL CELL SYSTEM WITH UNIFORM VAPOR DELIVERY OF FUEL” referenced above.

FIG. 6B is an exploded view of the fuel cell system 600. The fuel cell system 600 contains a first compression spring 605A, a frame 660A,B, C, and a second compression spring 605B.

A fuel distribution structure 650 provides a two way distribution to supply fuel to two fuel cells that are disposed on opposite sides of that structure. A first fuel cell has an MEA 620 and a second fuel cell has a second MEA 622. The fuel distribution structure 650 is, in the illustrative embodiment, a component having a fuel inlet 652, which is coupled in fluid communication with one or more serpentine flow channels 654.

The first fuel cell (which is the upper fuel cell in the figure, however, it should be understood that the assembly is orientation independent and thus will operate in orientations other that that shown in FIG. 6B) includes a methanol delivery film (MDF) layer 640 and a layer of polyvinyliden fluoride (PVFD) 630. PVDF is a highly non-reactive, pure thermoplastic fluoropolymer.

The first fuel cell has an anode current collector assembly 625 which is adjacent to an anode aspect of the MEA 620. Adjacent to a cathode aspect of the MEA 620 is an enthalpy exchanger and heat management assembly which is generally designated by reference number 618. The enthalpy exchanger and heat management assembly 618 includes a heat spreader assembly 100A that functions as a cold side element and a cathode flow field. An enthalpy exchange membrane 615 is located between the heat spreader assembly 100A and hot side element 610.

Similarly, the second fuel cell includes a second methanol delivery film (MDF) 642 and a second PVDF layer 632. In addition, the second fuel cell has an anode current collector assembly 627 which is adjacent to the anode aspect of the MEA 622 of that fuel cell. On the cathode side of the second fuel cell, is a second enthalpy exchanger and heat management assembly 616 which has a heat spreader assembly 100B that functions as a cold side element and a cathode flow field. An enthalpy exchange membrane 617 is located between the heat spreader assembly 100B and the hot side element 612.

In operation, fuel is delivered to fuel inlet 652 of the fuel distribution structure 654. Typically, the fuel is in a liquid form when it is delivered to the fuel inlet 652. In the meantime, the heat spreader elements 190 provide adequate heat for vaporizing the fuel. The heat needed to vaporize the fuel is about 5-10% of waste reaction heat. The vapor pressure caused as the fuel vaporizes acts to deliver the fuel to the MDF layers 640 and 642 in a generally uniform and even manner. The MDF layers help to further distribute the fuel through each anode current collector 625 and 627, to the respective anode aspects of the MEAs 620 and 622. The CO₂ resulting from the anode reaction is vented to the ambient which in turn causes the pressure in anode void spaces to be at ambient pressure. Because the vapor pressure of the fuel is higher than the ambient pressure, fuel tends to flow freely to fill any anode void spaces. The vapor pressure of the fuel allows it to fill such spaces, further adding to the uniformity of fuel distribution.

At the cathode side of each fuel cell, pressurized air is delivered to the cathode portion of the fuel cell through air inlet 611, 614. The enthalpy exchanger and heat spreader assembly 618 includes a heat spreader assembly 100A which has a bulk composite material layer 110 that is an electrically conductive element that also has flow channels formed therein. The bulk composite material layer 110 also functions as the cold side of the enthalpy exchanger.

A cold side element receives incoming pressurized air and directs the air towards the cathode aspect of the MEA 620. As is understood by those skilled in the art, oxygen in the air reacts with the hydrogen ions that cross the membrane to form water. The water is typically in vapor form. A microporous layer (not shown in FIG. 6B) may be used to push a certain amount of water back across the MEA to the anode side as needed for the anode reaction.

In turn, water vapor that is not pushed back to the anode side (mixed with unreacted air) is directed through the hot side of the enthalpy exchanger, along the enthalpy exchange membrane 615 that is disposed adjacent to the heat spreader assembly 100. The enthalpy exchange membrane 615 passes exhaust heat and water vapor to the incoming pressurized air that is directed by the cold side element. This allows the incoming air to be humidified, thereby avoiding cathode membrane dry out. In accordance with another aspect of the invention, the flow from the anode exhaust can be sent back into the hot side of the enthalpy exchanger to use the water from the anode to further humidify the incoming air stream.

A heat spreader assembly 100A is a thermally conductive assembly that provides the heat to vaporize the fuel, or to maintain a desired operating temperature in the MEA 620. The heat spreader assembly 100A acts to uniformly distribute air across the cathode aspect of the MEA 620.

Similarly, the second fuel cell has MEA 622 has an enthalpy exchanger and heat spreader assembly 616 that includes a heat spreader assembly 100B like that described above. Assembly 616 functions, in part, to uniformly distribute air across the cathode aspect of the MEA 622.

It should be understood that the heat spreader assembly of the present invention performs a number of functions within the fuel cell system. It acts as a current collector for the electricity generated by the fuel cell, and it acts as a flow field plate for the cathode and cold side of the enthalpy exchanger. The internal layer of the heat spreader assembly is the heat spreader layer. The lower layer is the cathode flow field plate 175 which distributes the air evenly across the cathode aspect of the MEA. It also provides compression for stabilization and integrity of the fuel cell system. With many functions being performed by a single component, this further reduces the number of components required in the fuel cell system, thereby contributing to the smaller form factor, and simplification of the manufacturing process.

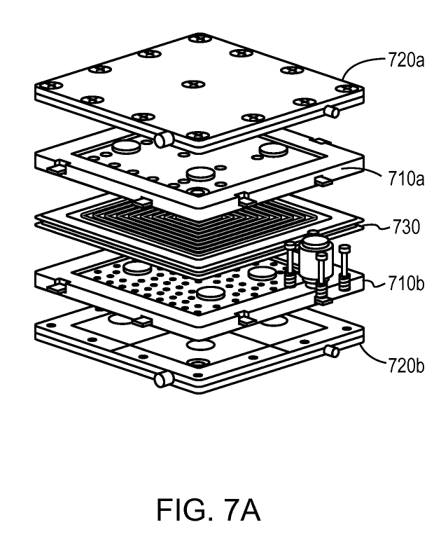

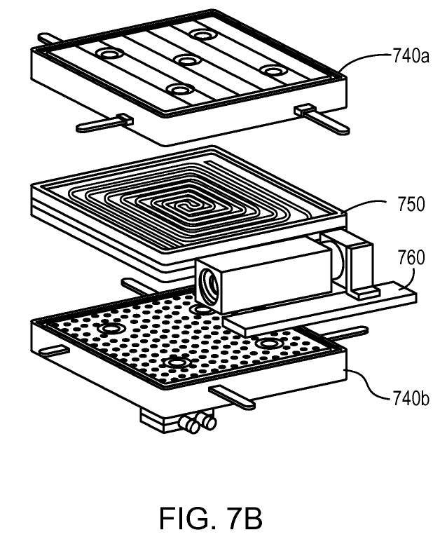

FIG. 7A depicts a central fuel and heat spreader assembly in accordance with one embodiment of the present invention. A central fuel/thermal plenum and heat switch assembly 730 is bonded to the anode side of each fuel cell 710a and 710b. An enthalpy exchanger 720a and 720b is fastened on the cathode side of each fuel cell. The central fuel/thermal plenum and heat switch assembly 730 acts as a heat spreader plate to distribute and maintain an even temperature across the MEA, where each fuel cell 720a and 720b includes an MEA. One advantage of this arrangement allows, only requires one heat spreader element in a two fuel cell stack. Additionally, fuel is fed to the two fuel cells 720a and 720b through the central fuel/thermal plenum and heat switch assembly 730.

FIG. 7B depicts a second central fuel and heat spreader assembly in accordance with another embodiment of the present invention. A fuel feed 750 is located between two fuel cells 740a and 740b. The fuel feed 750 includes a heat spreader element (not shown in FIG. 7B) that removes heat from a fuel cell reaction and maintains an even temperature across an associated MEA. (an MEA is part of fuel cell 740a and 740b). The heat spreader element includes a copper plate roll bonded to two stainless steel layers. (not shown in FIG. 7B). A lamination of a thermal set conductive composite material is applied to the stainless steel layers to enable heat to flow from the anode in each fuel cell 740a and 740b while maintaining low resistance among other layers of the fuel cell. In an alternative embodiment, the stainless steel layers can be formed from Aluminum or other similar materials. A heat switch 760 represents a mechanism that makes thermal contact between the heat spreader in the fuel feed 750 and the heat sink (not shown). The heat switch makes thermal contact with the heat sink when the fuel cell is too hot, and breaks the thermal contact when the fuel cell is too cold. One advantage of this arrangement allows, only requires one heat spreader element in a two fuel cell stack. Additionally, fuel is fed to the two fuel cells 740a and 740b through the fuel feed 750.

The foregoing description has been directed to specific embodiments of the invention. It will be apparent, however, that other variations and modifications may be made to the described embodiments, with the attainment of some or all of the advantages of such. Accordingly this description is to be taken only by way of example and not to otherwise limit the scope of the invention. Therefore, it is the object of the appended claims to cover all such variations and modifications as come within the true spirit and scope of the invention.

What is claimed is:

1. A heat spreader assembly for use in a fuel cell, the heat spreader assembly comprising:
a) a first element substantially comprised of a bulk composite material, having flow channels formed therein to evenly distribute incoming air for a cathode of the fuel cell;
b) a second element comprised of a substantially a plate acting as a heat spreader, said plate can be comprised of, but not limited to, a copper layer being roll bonded to two stainless steel layers, said stainless steel layers (or other metals such as aluminum) having a lamination of a thermal set conductive composite material, such lamination enabling heat and electricity to flow from a cathode while maintaining low resistance among other layers of the fuel cell whereby the heat spreader assembly acts as a heat spreader plate to 11 distribute heat to maintain an even temperature across the MEA.

2. A heat spreader assembly for use in a fuel cell, the heat spreader assembly comprising:
a) a first element substantially comprised of a bulk composite material, having flow channels formed therein to evenly distribute incoming air for a cathode of the fuel cell;
b) a second element comprised of a substantially a plate acting as a heat spreader, said plate can be comprised of a copper layer being roll bonded to two stainless steel layers, said stainless steel layers having a lamination of a thermal set conductive composite material, such lamination enabling heat and electricity to flow from a cathode while maintaining low resistance among other layers of the fuel cell whereby the heat spreader assembly acts as:
(i) a cathode flow field plate to evenly distribute air to the cathode aspect;
(ii) a heat spreader plate to distribute heat to maintain an even temperature across the MEA;
(iii) a heat conductor to direct heat in a predetermined location in the fuel cell;
(iv) a cold side of an enthalpy exchanger that acts to warm and/or transfer water from the exiting air stream to the incoming air stream;
(v) a cathode current collector; and
(vi) a structural component to add compression and stability to other layers of the fuel cell.

3. The heat spreader assembly as defined in claim 2 wherein said heat spreader removes heat from a fuel cell reaction and maintains an even temperature across an associated membrane electrode assembly.

4. The heat spreader assembly as defined in claim 2 wherein the assembly supplies electrons to the cathode of the fuel cell with minimum resistive loss.

5. The heat spreader assembly as defined in claim 2 further comprising passages in said first and second elements to distribute flow of air to the cathode and to distribute inlet air over the enthalpy exchange membrane.

6. The heat spreader assembly as defined in claim 2 is of sufficient stiffness to provide structural integrity to the fuel cell and to limit deflections in the assembly enabling adequate membrane electrode assembly compression across substantially the entirety of a surface area of the fuel cell.

7. The heat spreader assembly as defined in claim 2 wherein said copper plate is roll bonded to said stainless steel layers placed on either side of the copper plate.

8. The heat spreader assembly as defined in claim 2 wherein the bulk composite materials are glued to the stainless steel layers with a glue substance.

9. The heat spreader assembly as defined in claim 2 wherein said the bulk composite material is over molded to said stainless steel layers.

10. The heat spreader assembly as defined in claim 1 wherein the cold side of an enthalpy exchanger that acts to warm and/or transfer water from the exiting air stream to the incoming air stream is a third element made from a bulk composite material.

11. A heat spreader assembly for use in a fuel cell, the heat spreader assembly comprising:
a) a first element having flow channels formed therein to evenly distribute incoming air for a cathode of the fuel cell;
b) a second element comprising a heat spreader, said heat spreader enabling heat and electricity to flow from the cathode while maintaining low resistance among other layers of the fuel cell whereby said heat spreader assembly acts as a cathode flow field plate to evenly distribute air to the cathode aspect, a heat spreader plate to diffuse heat in desired manner to evaporate incoming fuel in the fuel cell, a cold side of an enthalpy exchanger that acts to transfer water based on a partial pressure gradient between a hot and a cold air stream, a cathode current collector, and a structural component to add compression and stability to other layers of the fuel cell, and wherein said first and second element are comprised of a single piece of molded material substantially formed from aluminum, which is sealed with a conductive impermeable coating substance.

12. A method for producing a heat spreader assembly for use in a fuel cell, the method comprising:
applying a thermal set adhesive to a top and bottom side of a copper plate roll bonded with stainless steel on both sides;
attaching bulk molded compound layers to the stainless steel layers to form a heat spreader, wherein the thermal set adhesive enables heat and electricity to flow from a cathode while maintaining low resistance among other layers of the fuel cell;
forming a bulk composite material with flow channels formed therein to evenly distribute incoming air for the cathode of the fuel cell and cold side of the enthalpy exchanger attaching the bulk composite material to the heat spreader at a high temperature in a heated press to form the heat spreader assembly, wherein the heat spreader assembly acts as:
(i) a cathode flow field plate to evenly distribute air to the cathode aspect;
(ii) a heat spreader plate to distribute heat to maintain an even temperature across the MEA
(iii) a heat conductor to direct heat in a predetermined location in the fuel cell;
(iv) a cold side of an enthalpy exchanger that acts to transfer water from the exiting air stream to the incoming air stream. (NOTE: This may be a third element and is made from a bulk composite material)
(v) a cathode current collector,
(vi) a structural component to add compression and stability to other layers of the fuel cell.

13. The method as defined in claim 12 wherein a gasket is used to isolate the air flow from the metallic components of the heat spreader assembly where flow has to go through the plate.

14. A method for producing a heat spreader assembly for use in a fuel cell, the method comprising:
roll-bonding layer of stainless steel to the top side and the bottom side of the copper plate to form a heat spreader and
molding a bulk composite material around the heat spreader to form the heat spreader assembly, wherein the bulk composite material is molded to have flow channels formed therein to evenly distribute incoming air for the cathode of the fuel cell and cold side of the enthalpy exchanger, wherein the heat spreader assembly acts as:
(i) a cathode flow field plate to evenly distribute air to the cathode aspect;
(ii) a heat spreader plate to distribute heat to maintain an even temperature across the MEA
(iii) a heat conductor to direct heat in a predetermined location in the fuel cell;
(iv) a cold side of an enthalpy exchanger that acts to transfer water from the exiting air stream to the incoming air stream. (NOTE: This may be a third element and is made from a bulk composite material)
(v) a cathode current collector,
(vi) a structural component to add compression and stability to other layers of the fuel cell.

15. A heat spreader assembly for use in a fuel cell, the heat spreader assembly comprising:
a) a first element substantially comprised of a bulk composite material, having flow channels formed therein to evenly distribute incoming methanol for a anode of the fuel cell;
b) a second element substantially comprised of a plate acting as a heat spreader, said plate includes a copper layer roll bonded to two stainless steel layers, said stainless steel layers having a lamination of a thermal set conductive composite material, such lamination enabling heat to flow from the anode while maintaining low resistance among other layers of the fuel cell whereby the heat spreader assembly acts as a heat spreader plate to distribute heat to maintain an even temperature across the MEA.

16. The heat spreader assembly as defined in claim 15 wherein said heat spreader removes heat from a fuel cell reaction and maintains an even temperature across an associated membrane electrode assembly.

17. The heat spreader assembly as defined in claim 15 wherein the assembly also conducts electrons from the anode of the fuel cell with minimum resistive loss.

18. The heat spreader assembly as defined in claim 15 wherein said copper plate is roll bonded to said stainless steel layers placed on either side of the copper plate.

19. The heat spreader assembly as defined in claim 15 wherein the bulk composite materials are glued to the stainless steel layers with a glue substance.

20. The heat spreader assembly as defined in claim 15 wherein said the bulk composite material is over molded to said stainless steel layers.

21. The heat spreader assembly as defined in claim 15 wherein the assembly supplies the heat for evaporating the incoming methanol.

22. The heat spreader assembly as defined in claim 15 wherein the assembly is located between each anode of two fuel cells arranged in a back to back configuration.
